(19) United States
(12) Patent Application Publication
(10) Pub. No.: US 2005/0117889 A1
(43) Pub. Date: Jun. 2, 2005

(54) Video reproducing apparatus and video reproducing method

(75) Inventor: Takahiro Seita, Mitaka-shi (JP)

Correspondence Address: PILLSBURY WINTHROP, LLP, P.O. BOX 10500, MCLEAN, VA, 22102, US

(73) Assignee: Kabushiki Kaisha Toshiba, Tokyo (JP)

(21) Appl. No.: 10/995,553

(22) Filed: Nov. 24, 2004

(30) Foreign Application Priority Data
Nov. 28, 2003 (JP) 2003-400903

(51) Int. Cl. H04N 5/781

(52) U.S. Cl. 386/95; 386/125

(57) ABSTRACT

When character information is added to a video signal as graphic characters, a graphic controller controls a display time or the information amount of the character information depending on a multiple-times reproduction speed of a recording medium. Further, when closed caption data is superimposed on a predetermined line of the video signal, a video decoder controls the information amount of the closed caption data depending on the multiple-times reproduction speed of the recording medium.

### CROSS-REFERENCE TO RELATED APPLICATIONS

This application is based upon and claims the benefit of priority from prior Japanese Patent Application No. 2003-400903, filed Nov. 28, 2003, the entire contents of which are incorporated herein by reference.

### BACKGROUND OF THE INVENTION

1. Field of the Invention

The present invention relates to a video reproducing apparatus and a video reproducing method for reproducing video signals recorded on, for example, a digital versatile disk (DVD).

2. Description of the Related Art

As is well known, in recent years, a high-density recording technique for information has been promoted, and an optical disk having a recording capacity of 4.7 GB per layer on one side has been made practicable.

An optical disk of this type includes, for example, reproduction-only DVD-Read only memory (DVD-ROM), rewritable DVD-Random Access Memory (DVD-RAM), DVD-Rewritable (DVD-RW), and write-once DVD-Recordable (DVD-R).

Closed caption data can also be recorded together with a video signal on such a DVD. In this case, the closed caption data is recorded in a user data area set for each 1 group of pictures (GOP) based on the Moving Picture Experts Group (MPEG) standard in the DVD format.

The video signal and the closed caption data are decoded when reproducing, respectively, and the closed caption data is superimposed on a line 21 of the video signal to be supplied to a closed-caption-enabled television. Thereby, the closed caption data can be displayed with the video signal.

However, when so-called multiple-times speed reproduction for reproducing a DVD at a speed an integer number of times as fast as a normal reproduction speed is performed, the number of frames of the output video signal is reduced. Thus, the amount of closed caption data capable of being superimposed on the line of the video signal is naturally reduced, and the closed caption data which cannot be superimposed on the line 21 is discarded.

As described above, the closed caption data, part of which is discarded, cannot be correctly displayed on a television so that the contents thereof cannot be understood. Further, when the discarded portion is taken up and then the closed caption data is decoded, the data may be displayed in a garbled manner.

Jpn. Pat. Appln. KOKAI Publication No. 2002-290894 discloses a structure where speech information intermittently reproduced in fast-forwarding reproduction in a digital videotape recorder can be visually confirmed by closed caption.

However, in Jpn. Pat. Appln. KOKAI Publication No. 2002-290894, since special reproduction data is recorded in a tape separately from normal reproduction data and a closed caption is combined to the special reproduction data, the structure is complicated and is not practicable.

### BRIEF SUMMARY OF THE INVENTION

According to one aspect of the present invention, there provided a video reproducing apparatus comprising: a reading unit configured to read data including a video signal and closed caption data from a recording medium; a signal processor configured to reproduce a video signal and closed caption data from data read in the reading unit; a graphic controller configured to add character information of closed caption data reproduced in the signal processor as graphic characters to a video signal reproduced in the signal processor; a first controller configured to control a display time or the information amount of character information to be added to a video signal by the graphic controller depending on a multiple-times reproduction speed of the recording medium; a video decoder configured to superimpose closed caption data reproduced in the signal processor on a predetermined line of a video signal reproduced in the signal processor; and a second controller configure to control the information amount of closed caption data to be superimposed on a predetermined line of a video signal by the video decoder depending on a multiple-times reproduction speed of the recording medium.

According to another aspect of the present invention, there is provided a video reproducing method comprising: reading data including a video signal and closed caption data from a recording medium; reproducing a video signal and closed caption data from read data, respectively; adding character information of reproduced closed caption data as graphic characters to a reproduced video signal; controlling a display time or the information amount of character information to be added to a video signal depending on a multiple-times reproduction speed of the recording medium; superimposing reproduced closed caption data on a predetermined line of a reproduced video signal; and controlling the information amount of closed caption data to be superimposed on a predetermined line of the video signal depending on a multiple-times reproduction speed of the recording medium.

### BRIEF DESCRIPTION OF THE SEVERAL VIEWS OF THE DRAWING

FIG. 1 is a block structure diagram for explaining an optical disk reproducing apparatus according to one embodiment of the present invention;

FIG. 2 is a diagram for explaining a reduction of the number of frames in multiple-times speed reproduction in the optical disk reproducing apparatus according to the embodiment;

FIG. 3 is a flowchart for explaining part of a control operation in multiple-times speed reproduction in the optical disk reproducing apparatus according to the embodiment;

FIG. 4 is a flowchart for explaining the remaining control operation in multiple-times speed reproduction in the optical disk reproducing apparatus according to the embodiment;

FIG. 5 is a diagram for explaining one example of a display form in each multiple-times speed reproduction when character information is added to a video signal according to the embodiment; and

FIG. 6 is a diagram for explaining one example of a control form in each multiple-times speed reproduction when closed caption data is superimposed on a line 21 of a video signal according to the embodiment.

### DETAILED DESCRIPTION OF THE INVENTION

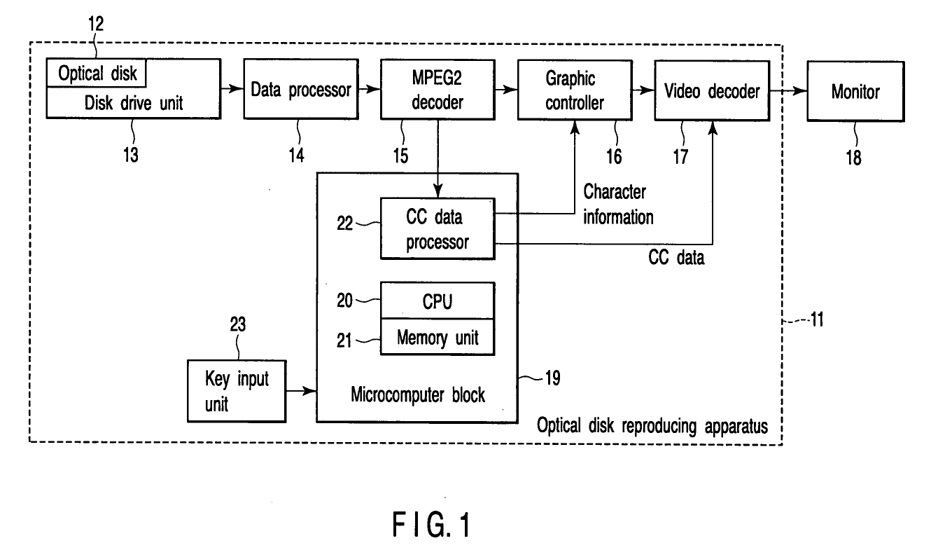

One embodiment according to the present invention will be described below in detail with reference to the drawings. FIG. 1 shows an optical disk reproducing apparatus 11 to be explained in this embodiment. This optical disk reproducing apparatus 11 reads out data by a disk drive unit 13 from an optical disk 12 on which the data is recorded based on a DVD format.

The data read by this disk drive unit 13 is supplied to a data processor 14 to be demodulated, and is then supplied to a MPEG2 decoder 15 to be recovered to a digital video signal.

The digital video signal output from the MPEG2 decoder 15 is supplied to a graphic controller 16 to be added with a graphic user interface (GUI) displayed video signal, and is then supplied to a video decoder 17. This video decoder 17 converts the input digital video signal into an analog video signal and outputs it to an external monitor 18 for video display.

This optical disk reproducing apparatus 11 is entirely controlled by a microcomputer block 19 for the entire operation including the reproducing operation. This microcomputer block 19 has a central processing unit (CPU) 20, a memory unit 21, and a closed caption (CC) data processor 22, and receives operation information input in a key input unit 23 to control each unit such that the operation contents are reflected.

In this case, the memory unit 21 includes a read-only memory storing therein a control program to be executed by the CPU 20, a read/write memory for providing a work area for the CPU 20, a non-volatile memory storing therein various setting information and control information, and the like.

The CC data processor 22 can capture the closed caption data from user data in the data demodulated in the MPEG2 decoder 15, and can output character information corresponding to the closed caption data to the graphic controller 16.

In this case, the graphic controller 16 adds the character information output from the CC data processor 22 as graphic characters to the video signal output from the MPEG2 decoder 15 and outputs the same.

This CC data processor 22 can output the captured closed caption data to the video decoder 17. In this case, the video decoder 17 superimposes the input closed caption data on the line 21 of the analog video signal and outputs the same.

The CC data processor 22 allows the user to select whether to output the character information to the graphic controller 16 or to output the closed caption data to the video decoder 17.

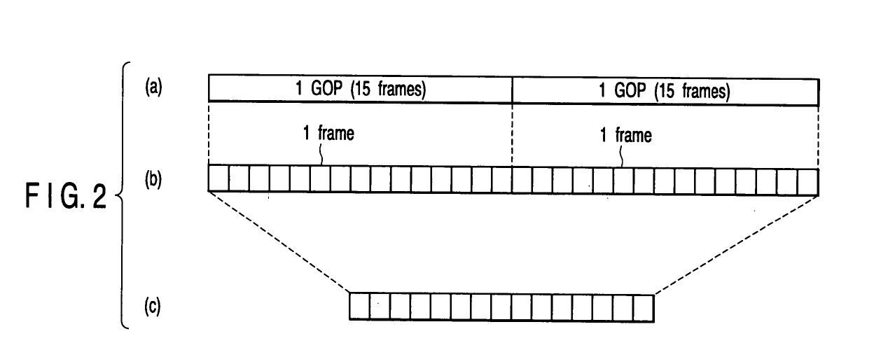

A video signal for 1 second based on the MPEG standard is composed of 2GOPs as indicated by a numeral (a) in FIG. 2. 1GOP is composed of 15 frames as indicated by a numeral (b) in FIG. 2.

In the DVD format, a user data area is present for 1GOP, where the closed caption data for 1GOP is recorded. In this case, the closed caption data is limited to 2 bytes per frame so that 1GOP contains 30 bytes.

Since the frames to be output are reduced to 15 frames in double-speed reproduction of the optical disk 12 which is half as many as in the normal reproduction as indicated by a numeral (c) in FIG. 2, all the closed caption data for 60 bytes cannot be superimposed on the line 21 in 2GOPs so that the extra closed caption data is discarded and cannot be correctly displayed.

The microcomputer block 19 controls the character information to be output to the graphic controller 16 and the closed caption data to be output to the video decoder 17 via the CC data processor 22 depending on the multiple-times reproduction speed in the multiple-times speed reproduction of the optical disk 12.

As for this controlling, when low multiple-times speed reproduction such as double-speed reproduction whose speed is near the normal reproduction speed is employed, a display interval is made short, and when high multiple-times speed reproduction such as 15-times speed reproduction is employed, the display interval is made short and the data is made thinner to reduce the display amount.

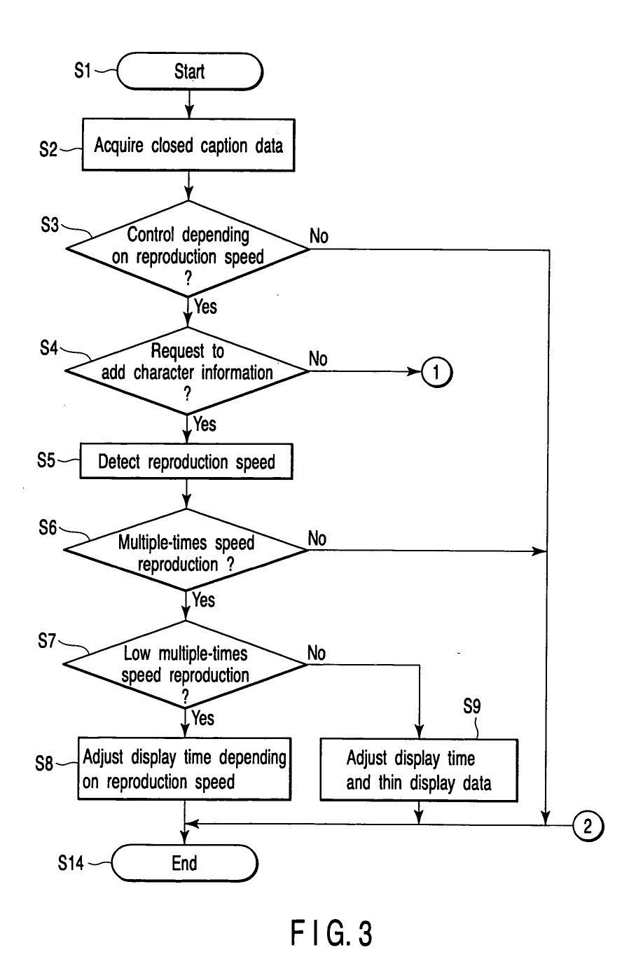

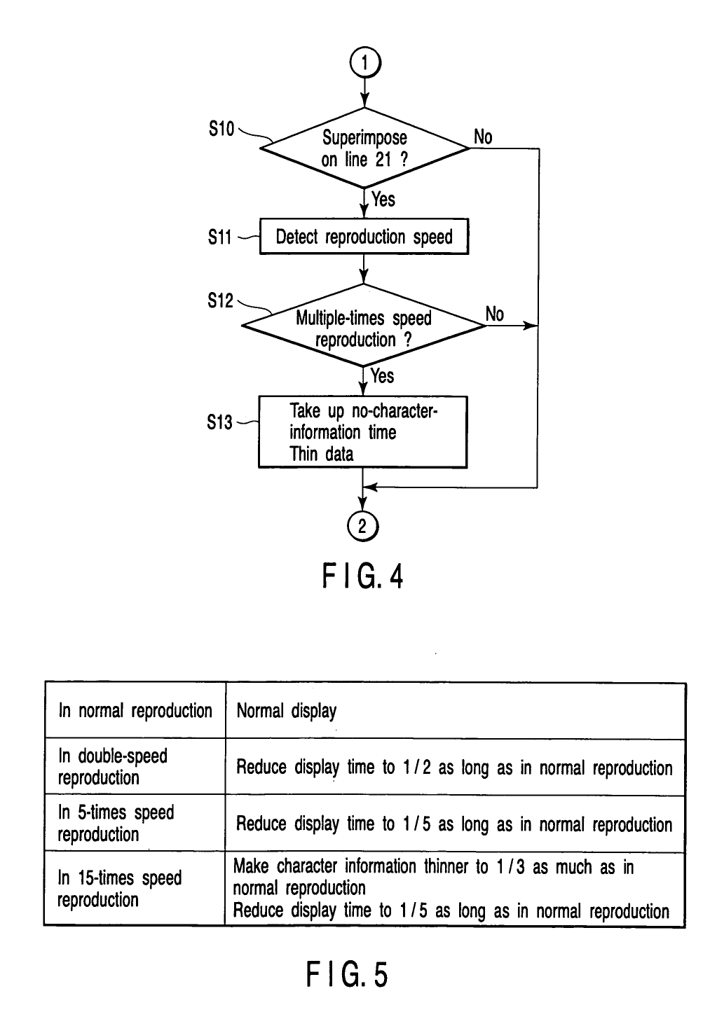

FIGS. 3 and 4 show flowcharts for the control operation by the microcomputer block 19. In other words, when started (step S1), in step S2 the microcomputer block 19 acquires the closed caption data from the user data in the data demodulated in the MPEG2 decoder 15.

Then, in step S3 the microcomputer block 19 determines whether to be set for controlling the closed caption data depending on the multiple-times reproduction speed, and when determined that the block 19 is not set therefor (NO), the processing is terminated (step S14). The user can select whether to set the closed caption data to be controlled depending on the multiple-times reproduction speed.

When determined in step S3 that the closed caption data is set to be controlled depending on the multiple-times reproduction speed (YES), in step S4 the microcomputer block 19 determines whether the character information is set to be added to the video signal as the graphic characters by the graphic controller 16.

When determined that the character information is set to be added to the video signal by the graphic controller 16 (YES), in step S5 the microcomputer block 19 detects a reproduction speed, in step S6 it is determined whether the block 19 is in multiple-times speed reproduction, and when determined that the block 19 is not in multiple-times speed reproduction (NO), the processing is terminated (step S14).

When determined in step S6 that the block 19 is in multiple-times speed reproduction (YES), in step S7 the microcomputer block 19 determines whether to be in low multiple-times speed reproduction, and when determined that the block 19 is in low multiple-times speed reproduction (YES), in step S8 the display time of the character information is controlled to be short as the reproduction speed becomes faster and the processing is terminated (step S14).

In contrast, when determined in step S7 that the block 19 is not in low multiple-times speed reproduction (NO), it is determined that the microcomputer block 19 is in high multiple-times speed reproduction, in step 9 the display time of the character information is reduced as long as the characters can be viewed as the reproduction speed becomes faster, and the character information which cannot be displayed is controlled to be made thinner and the processing is terminated (step S14).

When making the character information thinner, the controlling is performed such that continuity of the characters is not lost or a display form such as garbled characters does not occur in consideration of breaking information, blank information, page breaking information, punctuation, and the like. For example, the controlling is avoided which causes a missing character in a consecutive character string such as a character string of “abcdefghijklmn” to “abcjkimn”. Further, since the information amount made thinner can be calculated from the reproduction speed, the calculation result is also used for the controlling.

When determined in step S4 that the character information is not set to be added to the video signal by the graphic controller 16 (NO), in step S10 the microcomputer block 19 determines whether the closed caption data is set to be superimposed on the line 21 of the video signal by the video decoder 17, and when determined that the data is not set as such (NO), the processing is terminated (step S14).

In contrast, when determined in step S10 that the closed caption data is set to be superimposed on the line 21 of the video signal (YES), in step S11 the microcomputer block 19 detects the reproduction speed, in step 12 it is determined whether the block 19 is in multiple-times speed reproduction, and when determined that the block 19 is not in multiple-times speed reproduction (NO), the processing is terminated (step S14).

When determined in step S12 that the block 19 is in multiple-times speed reproduction (YES), since the number of frames capable of superimposing the closed caption data is reduced as the reproduction speed becomes faster, in step S13 the computer block 19 takes up times having no character information and makes the closed caption data thinner in collective units depending on the reproduction speed to superimpose the same on the line 21, and the processing is terminated (step S14).

Also in this case, when the closed caption data is made thinner, the controlling needs to be performed such that continuity of the characters is not lost or the display form such as garbled characters does not occur in consideration of breaking information, blank information, page breaking information, punctuation, and the like. Further, since the amount data is made thinner can be calculated from the reproduction speed, the calculation result is also used for the controlling.

According to the embodiment, since there is constituted such that the display interval adjustment or the amount data is made thinner is performed depending on the multiple-times reproduction speed and the continuity of the characters is not lost in consideration of breaking information, blank information, page breaking information, punctuation, and the like when making the data thinner, the closed caption data whose contents can be determined also in the multiple-times speed reproduction can be displayed instead of separately recording dedicated data, which is enough practical.

FIG. 5 shows one example of a form of displaying the closed caption data in normal reproduction, double-speed reproduction, 5-times speed reproduction, and 15-times speed reproduction when the graphic controller 16 adds the character information to the video signal to display the closed caption data.

In other words, the character information is displayed for a normal display time in the normal reproduction instead of being made thinner. The character information is displayed for the display time in the double-speed reproduction half as long as in the normal reproduction, and the character information is displayed for the display time in the 5-times speed reproduction ⅕ as long as in the normal reproduction. Further, in the 15-times speed reproduction, the character information is displayed for the display time ⅕ as long as in the normal reproduction and is thinned to ⅓ as much as in the normal reproduction.

The display time is made short because as the reproduction speed becomes faster, the closed caption data is acquired at a speed depending thereon so that the display is changed depending on the speed at which the closed caption data can be acquired.

In the 15-times speed reproduction, the character information is made thinner and the display time is reduced. The character information is made thinner by first retrieving a control code for acquiring a character code from the closed caption data and displaying the character code subsequent to this code up to a period, a no-data portion, or a next control code. Thereafter, data double as much as the closed caption data previously used for display is discarded and is displayed again from the subsequent control code so that the character information can be made thinner to ⅓.

The reduction of the display time to ½ or ⅕ as long as in the normal reproduction means that the character information is displayed only for a period of ⅕ the frames required in the normal reproduction.

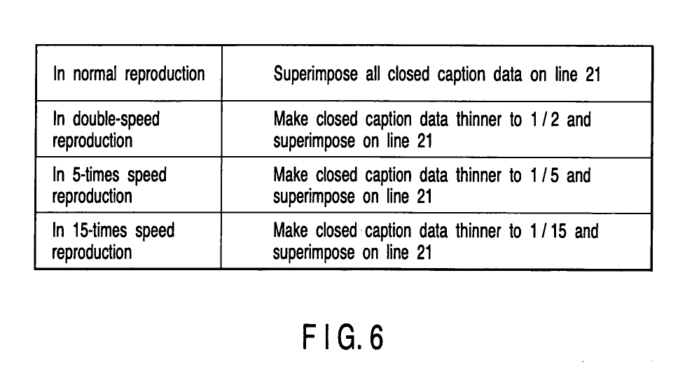

FIG. 6 shows one example of a form of controlling the closed caption data in normal reproduction, double-speed reproduction, 5-times speed reproduction, and 15-times speed reproduction when the video decoder 17 superimposes the closed caption data on the line 21 of the video signal.

In other words, all the closed caption data is superimposed on the line 21 of the video signal in the normal reproduction instead of being made thinner. Further, the closed caption data is made thinner to ½ and superimposed on the line 21 in the double-speed reproduction, the closed caption data is made thinner to ⅕ and superimposed on the line 21 in the five-times speed reproduction, and the closed caption data is made thinner to 1/15 and superimposed on the line 21 in the 15-times speed reproduction.

The making thinner is performed by retrieving a control code for acquiring a character code from the closed caption data and superimposing the character code subsequent to this code on the line 21 up to a period, a no-data portion, or a next control code. Thereafter, data for frames depending on the amount made thinner among the frames previously superimposed on the line 21 is discarded and the data is superimposed again on the line 21 from the subsequent control code.

For example, in the case of making thinner to ½, data for the frames as many as superimposed on the line 21 is discarded, and in the case of making thinner to ⅕, data for the frames 14 times as many as superimposed on the line 21 is discarded.

In this case, it is advantageous that the character code from the control code up to the next control code is not superimposed on the line 21 and the character code from the control code up to a period or a no-data portion is superimposed on the line 21 instead. This is because a breaking portion is contained in the character code when delimiting at the control code, thereby a sentence may be broken in the middle.

The present invention is not limited to the above embodiment, and the constituents can be variously modified and embodied within the scope without departing from the spirit in the practice. A plurality of constituents disclosed in the embodiment can be appropriately combined to form various inventions. For example, some constituents may be deleted from all the constituents shown in the embodiment. Further, constituents according to different embodiments may be appropriately combined.

1. A video reproducing apparatus comprising:
a reading unit configured to read data including a video signal and closed caption data from a recording medium;
a signal processor configured to reproduce a video signal and closed caption data from data read in the reading unit;
a graphic controller configured to add character information of closed caption data reproduced in the signal processor as graphic characters to a video signal reproduced in the signal processor;
a first controller configured to control a display time or the information amount of character information to be added to a video signal by the graphic controller depending on a multiple-times reproduction speed of the recording medium;
a video decoder configured to superimpose closed caption data reproduced in the signal processor on a predetermined line of a video signal reproduced in the signal processor; and
a second controller configure to control the information amount of closed caption data to be superimposed on a predetermined line of a video signal by the video decoder depending on a multiple-times reproduction speed of the recording medium.

2. A video reproducing apparatus according to claim 1, wherein the first controller controls such that a display time of character information to be added to a video signal by the graphic controller in low multiple-times speed reproduction of the recording medium is shorter than in normal reproduction, and
controls such that a display time of character information to be added to a video signal by the graphic controller in high multiple-times speed reproduction of the recording medium is shorter than in normal reproduction and the information amount is less than in normal reproduction.

3. A video reproducing apparatus according to claim 1, wherein the first controller controls such that a display time of character information to be added to a video signal by the graphic controller in n-times low speed reproduction of the recording medium is reduced to 1/n as long as in normal reproduction.

4. A video reproducing apparatus according to claim 1, wherein the first controller controls such that character information to be added to a video signal by the graphic controller is thinned by units from a character code subsequent to a predetermined control code of closed caption data reproduced in the signal processor up to any one of a period, a no-data portion, and a next control code.

5. A video reproducing apparatus according to claim 1, wherein the second controller controls such that the information amount of closed caption data to be superimposed on a predetermined line of a video signal by the video decoder in n-times speed reproduction of the recording medium is made thinner to 1/n as much as in normal reproduction.

6. A video reproducing apparatus according to claim 1, wherein the second controller controls such that closed caption data to be superimposed on a predetermined line of a video signal by the video decoder is made thinner by units from a character code subsequent to a predetermined control code of closed caption data reproduced in the signal processor up to any one of a period, a no-data portion, and a next control code.

7. A video reproducing apparatus according to claim 1, wherein the recording medium is a disk on which data is recorded based on a DVD format, and the closed caption data is superimposed on a line 21 of the video signal by 2 bytes per frame.

8. A video reproducing method comprising:
reading data including a video signal and closed caption data from a recording medium;
reproducing a video signal and closed caption data from read data, respectively;
adding character information of reproduced closed caption data as graphic characters to a reproduced video signal;
controlling a display time or the information amount of character information to be added to a video signal depending on a multiple-times reproduction speed of the recording medium;
superimposing reproduced closed caption data on a predetermined line of a reproduced video signal; and
controlling the information amount of closed caption data to be superimposed on a predetermined line of the video signal depending on a multiple-times reproduction speed of the recording medium.

9. A video reproducing method according to claim 8, wherein a display time or the information amount of character information to be added to the video signal is controlled depending on a multiple-times reproduction speed of the recording medium,
the character information to be added to the video signal is controlled in low multiple-times speed reproduction of the recording medium such that the display period is shorter than in normal reproduction, and
the character information to be added to the video signal is controlled in high multiple-times speed reproduction of the recording medium such that the display time is shorter than in normal reproduction and the information amount is less than in normal reproduction.

10. A video reproducing method according to claim 8, wherein a display time or the information amount of character information to be added to the video signal is controlled depending on a multiple-times reproduction speed of the recording medium, and
the display time of the character information to be added to the video signal in n-times low speed reproduction of the recording medium is reduced to 1/n as long as in normal reproduction.

11. A video reproducing method according to claim 8, wherein a display time or the information amount of character information to be added to the video signal is controlled depending on a multiple-times reproduction speed of the recording medium, and
the character information to be added to the video signal is made thinner by units from a character code subsequent to a predetermined control code of reproduced closed caption data up to any one of a period, a no-data portion, and a next control code.

12. A video reproducing method according to claim 8, wherein the information amount of closed caption data to be superimposed on a predetermined line of the video signal is controlled depending on a multiple-times reproduction speed of the recording medium, and
the information amount of closed caption data to be superimposed on a predetermined line of the video signal in n-times speed reproduction of the recording medium is made thinner to 1/n as much as in normal reproduction.

13. A video reproducing method according to claim 8, wherein the information amount of closed caption data to be superimposed on a predetermined line of the video signal is controlled depending on a multiple-times reproduction speed of the recording medium, and
the closed caption data to be superimposed on a predetermined line of the video signal is made thinner by units from a character code subsequent to a predetermined control code of reproduced closed caption data up to any one of a period, a no-data portion, and a next control code.
